(19) United States
(12) Patent Application Publication
(10) Pub. No.: US 2002/0057549 A1
(43) Pub. Date: May 16, 2002

(54) Activated carbon for electrode of electric double-layer capacitor

(76) Inventors: Shigeki Oyama, Saitama (JP); Minoru Noguchi, Saitama (JP); Takeshi Fujino, Saitama (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/946,560

(22) Filed: Sep. 6, 2001

(30) Foreign Application Priority Data
Sep. 8, 2000 (JP) 2000-272472

(51) Int. Cl. H01G 4/005; H01G 9/00

(52) U.S. Cl. 361/303; 361/502

(57) ABSTRACT

An activated carbon for an electrode of an electric double-layer capacitor includes a plurality of crystallites having a graphite structure in an amorphous carbon, in which the interlaminar distance d₀₀₂ of the plurality of crystallites is in a range of 0.388≦d₀₀₂≦0.420 nm.

### BACKGROUND OF THE INVENTION

1. Field of the Invention

The present invention relates to an activated carbon for an electrode of an electric double-layer capacitor and particularly, an activated carbon for an electrode including a plurality of crystallites having a graphite structure in an amorphous carbon.

2. Description of the Related Art

There is a conventionally known activated carbon for an electrode, in which the interlaminar distance d₀₀₂ of the plurality of crystallites is in a range of 0.36 ≦d₀₀₂≦0.385 nm (see Japanese Patent Application Laid-open No. 11-317333).

In the known activated carbon for the electrode, however, the electrostatic capacity density exceeds 20 F/cc, which has been alleged hitherto to be a limit, but it cannot exceed 30 F/cc. Therefore, in order to enhance the performance of the electric double-layer capacitor, it would be advantageous to further increase the electrostatic capacity density (F/cc).

### SUMMARY OF THE INVENTION

It is an object of the present invention to provide an activated carbon of the above-described type for an electrode, wherein the electrostatic capacity density per unit volume can be increased to 30 F/cc or more.

To achieve the above-described object, according to the present invention, there is provided an activated carbon for an electrode of an electric double-layer capacitor including a plurality of crystallites having a graphite structure in an amorphous carbon, in which the interlaminar distance d₀₀₂ of the plurality of crystallites is in a range of 0.388≦d₀₀₂≦0.420 nm.

With the above configuration, the area of an edge face of the crystallites exposed to an inner surface of each of the pores in the activated carbon for an electrode to govern the electrostatic capacity density (F/cc) per unit volume can be increased remarkably, for example, by an increase in the electrostatic capacity density to 30 F/cc or more. However, if the interlaminar distance d₀₀₂ is smaller than 0.388 nm, the increased electrostatic capacity density per unit volume cannot be achieved. On the other hand, if d₀₀₂ >0.420, electrostatic capacity density (F/cc) is substantially constant.

### BRIEF DESCRIPTION OF THE DRAWINGS

The preferred embodiments of this invention are described below in conjunction with the drawings, in which:

FIG. 1 is a partially broken-away front view of a portion of a button-type electric double-layer capacitor;

FIG. 2 is a diagram illustrating the structure of an activated carbon for an electrode;

FIG. 3 is a diagram illustrating a graphite structure;

FIG. 4 is a graph showing the relationship between the interlaminar distance and the electrostatic capacity density per unit volume; and

FIG. 5 is a graph showing the relationship between the interlaminar distance and the electrostatic capacity density per unit volume as well as the electrode density.

### DETAILED DESCRIPTION OF THE PREFERRED EMBODIMENTS

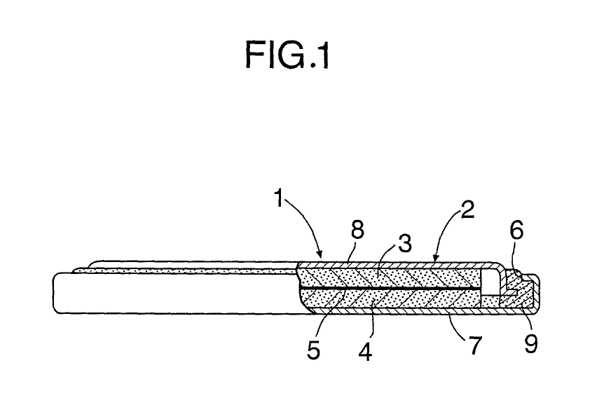

Referring to FIG. 1, an embodiment of a button-type electric double-layer capacitor 1 includes a case 2, a pair of polarized electrodes 3 and 4 accommodated in the case 2, a spacer 5 sandwiched between the polarized electrodes 3 and 4, and an electrolyte filled in the case 2. The case 2 comprises a body 7, for example, made of aluminum, and having an opening 6, and a lid plate 8, for example, made of aluminum, for closing the opening 6. An outer periphery of the lid plate 8 and an inner periphery of the body 7 are sealed from each other by a seal material 9. Each of the polarized electrodes 3 and 4 is preferably made of a mixture including activated carbon for an electrode, a conductive filler and a binder.

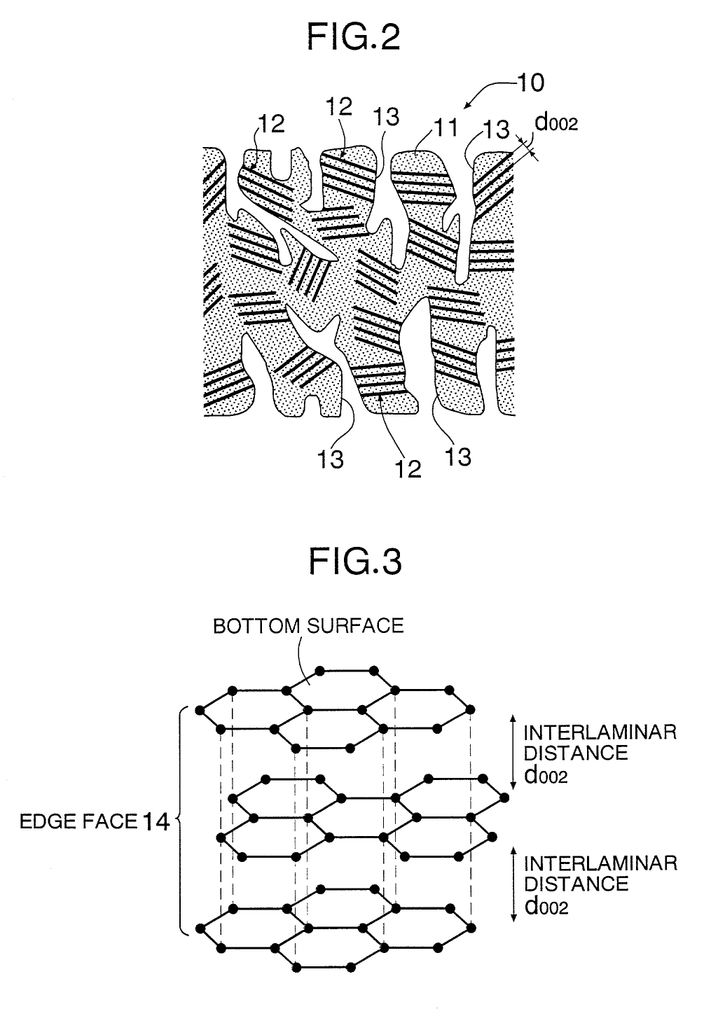

As shown in FIGS. 2 and 3, the activated carbon 10 for the electrode has a plurality of crystallites 12 having a graphite structure in amorphous carbon 11, and the interlaminar distance d₀₀₂ in at least some (and preferably in all or substantially all) of the crystallites 12 is set in a range of 0.388 nm≦d₀₀₂0.420 nm.

With such a configuration, the area of an edge face 14 of the crystallites 12 exposed to an inner surface of each of pores 13 in the activated carbon 10 for electrode to govern the electrostatic capacity density (F/cc) per unit volume can be increased remarkably, thereby increasing the electrostatic capacity density to 30 F/cc or more.

Such activated carbon 10 for the electrode can be produced by a process in accordance with embodiments of this invention as described below.

In embodiments, this process includes a step of forming a fiber by conducting spinning using a meso-fused pitch which is a starting material of easily-graphitizable carbon, a step of subjecting the fibrous material to an infusibilizing treatment at a heating temperature T set in a range of 200° C. ≦T ≦400° C. for a heating time t set in a range of 0.5 hour≦t≦10 hours in an atmospheric current, a step of subjecting the infusibilized fiber to a carbonizing treatment at a heating temperature T set in a range of 600° C. ≦T≦900° C. for a heating time t set in a range of 0.5 hour≦t≦10 hours in an inert gas current to provide a fibrous carbonized material, a step of subjecting the fibrous carbonized material to a pulverizing treatment to provide a powdered carbonized material, a step of subjecting the powdered carbonized material to an alkali activating treatment at a heating temperature T set in a range of 500° C. ≦T≦1,000° C. for a heating time t set in a range of 0.5 hour≦t≦10 hours in an inert gas atmosphere, followed by an acid-washing, a water-washing, a filtration and a drying, thereby providing activated carbon.

Examples of the starting material of easily-graphitizable carbon, which may be used in addition to meso-fused pitch, include coke, petroleum pitch, a polyvinyl chloride, a polyimide, PAN and the like. The conditions in each of the treatments are set as described below from the viewpoints of achieving an intended purpose in each of the treatments and maintaining the characteristic of the material to be treated.

Particular examples are described below.

I. Production of Activated Carbon for Electrode

(a) A fiber having a diameter of 13 μm was produced by conducting a spinning using a meso-fused pitch. (b) The fiber was subjected to an infusibilizing treatment at 320° C. for 1 hour in the atmospheric current. (c) The infusibilized fiber was subjected to a carbonizing treatment at 650° C. for 1 hour in a nitrogen gas current to provide a carbonized fibrous material. (d) The carbonized fibrous material was pulverized to provide a powdered carbonized material having an average particle size of 20 μm.

Alkali Activating Treatment

(a) The powdered carbonized material was mixed thoroughly with an amount of KOH pellet two times the amount of the powdered carbonized material and then, the resulting mixture was filled in a boat made of Inconel. (b) The boat was placed into a tubular furnace and maintained at 700° C. in a nitrogen gas current for 5 hours. Then, the boat was removed from the tubular furnace, and the powder was subjected to a washing using HCl for removal of KOH, a washing using warm water, a filtration and a drying, thereby producing activated carbon having an average particle size of 20 μm for an electrode.

The activated carbon for the electrode produced in the above manner is referred to as Example 1. Examples 2 to 5 and Comparative Examples 1 to 4 of activated carbons for electrodes were produced under the same atmosphere conditions as in the production of the Example 1, except that the temperature and the time in the production of the powdered carbonized material and/or the temperature and the time in the alkali activating treatment were changed.

Measurement of Interlaminar Distance d₀₀₂

An interlaminar distance d₀₀₂ for each of the Examples was determined by an X-ray diffraction measurement. More specifically, each of the Examples was dried and filled into a recess having a length of 25 mm and a width of 25 mm in a glass cell to prepare a sample. The sample was placed into an X-ray diffraction device.

Then, the sample was subjected to a step scanning process under the following conditions to provide an X-ray diffraction pattern: A range of measuring angle was in a range of 15 to 30 degree at 2θ; a target was Cu; a tube voltage was 40 kV; a tube current was 100 mA; a step width was 0.05 deg.; and a counting time was 1.0 sec. Then, the X-ray diffraction pattern was analyzed under the following conditions: A noise condition at a half-value width was 0.5 deg.; a noise level was 5.0; and a peak analysis in a number of differentiation points was 20.0.

A face-face distance d was determined from an analyzed diffraction peak and defined as an interlaminar distance d₀₀₂ .

Table 1 shows the producing conditions and the interlaminar distance d₀₀₂ ₂ for each of the Examples 1 to 5 and the comparative Examples 1 to 4.

TABLE 1

| | Production of | | | | |
|---|---|---|---|---|---|
| | powdered car- | | Alkali activating | | |
| | bonized material | | treatment | | Interlaminar |
| | Temperature | | Temperature | | distance d₀₀₂ |
| | (° C.) | Time | (° C.) | Time | (nm) |
| Ex. 1 | 650 | 1 | 700 | 5 | 0.416 |
| Ex. 2 | 650 | 1 | 800 | 5 | 0.407 |
| Ex. 3 | 700 | 1 | 700 | 5 | 0.400 |
| Ex. 4 | 700 | 1 | 800 | 5 | 0.395 |
| Ex. 5 | 750 | 1 | 700 | 5 | 0.388 |
| Com. | 770 | 1 | 700 | 5 | 0.375 |
| Ex. 1 | | | | | |
| Com. | 770 | 1 | 800 | 5 | 0.370 |
| Ex. 2 | | | | | |
| Com. | 800 | 1 | 700 | 5 | 0.365 |
| Ex. 3 | | | | | |
| Com. | 800 | 1 | 800 | 5 | 0.360 |
| Ex. 4 | | | | | |

Ex. = Example
Com. Ex. = Comparative Example

II Fabrication of Button-type Electric Double-layer Capacitor

In Example (1), a graphite powder (a conductive filler) and PTFE (a binder) were weighed so that a weight ratio of 90:5:5 was provided. Then, the weighed materials were kneaded together and then subjected to a rolling, thereby fabricating an electrode sheet having a thickness of 185 μm. Two polarized electrodes 3 and 4 having a diameter of 20 mm were cut from the polarized sheet. Then, a button-type electric double-layer capacitor 1 shown in FIG. 1 was fabricated using the two polarized electrodes 3 and 4, a spacer 5 made of PTFE and having a diameter of 20 mm and a thickness of 75 μm, an electrolyte and the like. The electrolyte used was a 1.5 M solution of triethylmethyl ammonium-tetrafluoroborate [(C₂H₅)₃CH₃NBF₄] in propylene carbonate.

Nine button-type electric double-layer capacitors were fabricated in the same manner using the Examples 2 to 5 and the Comparative Examples 1 to 4.

III. Electrode density and electrostatic capacity density of activated carbon for electrode

An electrode density of each of the electric double-layer capacitors was measured. Each of the electric double-layer capacitors was subjected to charging and discharging cycles and then, electrostatic capacity densities (F/g and F/cc) of each of the activated carbons for the electrodes were determined by an energy conversion process. In the charging and discharging cycles, the charging for 90 minutes and the discharging for 90 minutes were conducted two times at 2.7 V and two times at 2.8 V and two times at 3.0 V and two times at 2.7 V.

Table 2 shows the interlaminar distance d₀₀₂, the electrode density, the electrostatic capacity density (F/g) of the activated carbon per unit weight and the electrostatic capacity density (F/cc) per unit volume for each of the examples.

TABLE 2

| | | | Electrostatic | Electrostatic |
|---|---|---|---|---|
| | Interlaminar | Electrode | capacity | capacity |
| | distance | density | density | density |
| | d002 (nm) | (g/cc) | (F/g) | (F/cc) |
| Ex. 1 | 0.416 | 0.81 | 41.5 | 33.6 |
| Ex. 2 | 0.407 | 0.79 | 41.2 | 32.5 |
| Ex. 3 | 0.400 | 0.81 | 40.4 | 32.7 |
| Ex. 4 | 0.395 | 0.81 | 39.4 | 31.9 |
| Ex. 5 | 0.388 | 0.85 | 37.2 | 31.6 |
| Com. Ex. 1 | 0.375 | 0.86 | 29.8 | 25.6 |
| Com. Ex. 2 | 0.370 | 0.87 | 25.0 | 21.8 |
| Com. Ex. 3 | 0.365 | 0.89 | 21.4 | 19.0 |
| Com. Ex. 4 | 0.360 | 0.94 | 17.7 | 16.6 |

Ex. = Example
Com. Ex. = Comparative example

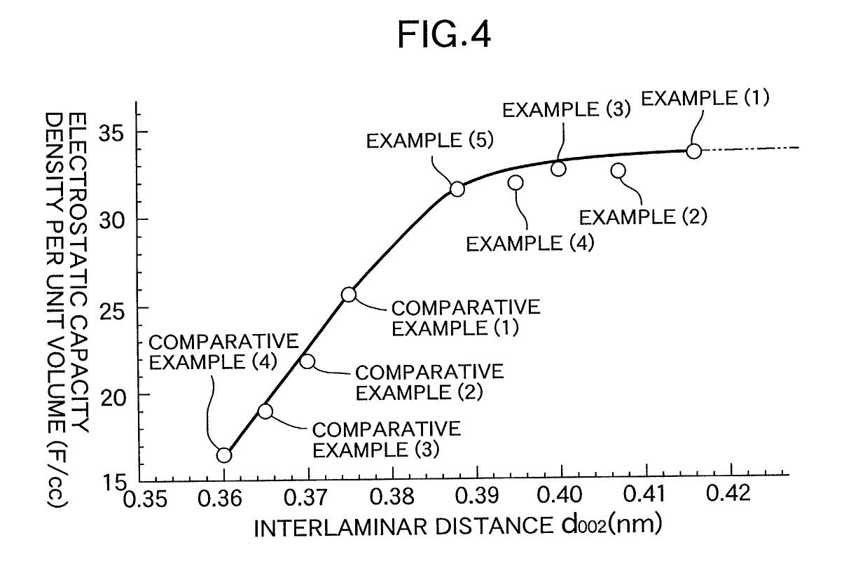

FIG. 4 is a graph taken based on Table 2 and showing the relationship between the interlaminar distance d₀₀₂ and the electrostatic capacity density (F/cc) per unit volume for each of the Examples 1 to 5 and the Comparative Examples 1 to 4. As is apparent from Table 2 and FIG. 4, when the interlaminar distance d₀₀₂ of the crystallites is set at a value of d₀₀₂ ≧0.388 nm, the electrostatic capacity density of the activated carbon for the electrode can be increased to 30 F/cc or more. On the other hand, if the interlaminar distance d₀₀₂ is equal to or larger than 0.420, the electrostatic capacity density (F/cc) is substantially constant.

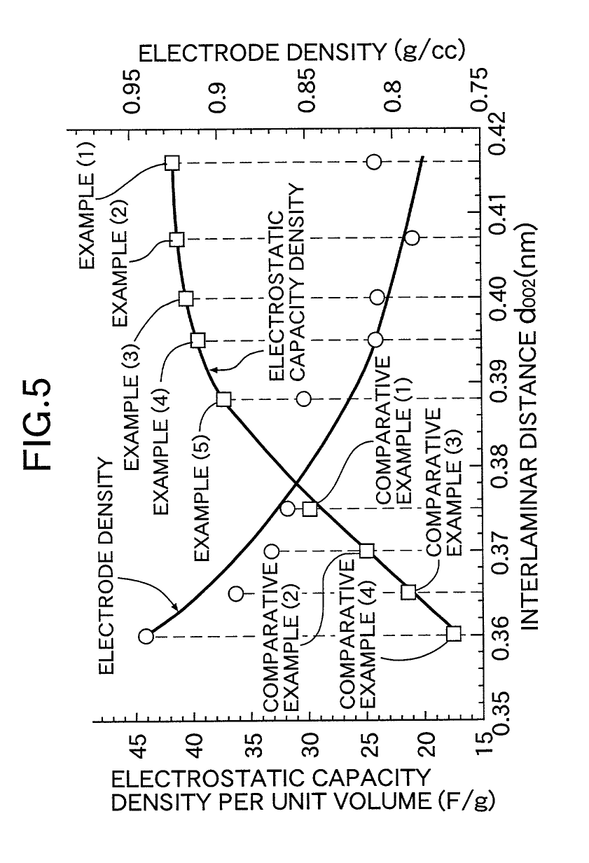

FIG. 5 is a graph taken based on Table 2 and showing the relationship between the interlaminar distance d₀₀₂ ₂ and the electrostatic capacity density (F/g) per unit weight as well as the electrode density for each of the Examples 1 to 5 and the Comparative Examples 1 to 4. As apparent from Table 2 and FIG. 5, a point of inflection in the electrostatic capacity density (F/g) per unit weight appears at the interlaminar distance d₀₀₂ equal to 0.388 nm.

Thus, according to embodiments of the present invention, it is possible to provide an activated carbon for an electrode of an electric double-layer capacitor, which has an electrostatic capacity density per unit volume increased to 30 F/cc or more by forming the activated carbon into the above-described configuration.

What is claimed is:

1. An activated carbon for an electrode of an electric double-layer capacitor including a plurality of crystallites having a graphite structure in an amorphous carbon, wherein the interlaminar distance d₀₀₂ of the plurality of crystallites is in a range of 0.388≦d₀₀₂≦0.420 nm.

2. The activated carbon of claim 1 wherein the activated carbon is contained in an electric double-layer capacitor.

3. The activated carbon of claim 2 wherein the electrostatic capacity density per unit volume of the electric double-layer capacitor is 30 F/cc or more.

4. A method for preparing the activated carbon of claim 1, comprising:
a step of forming a fiber by conducting spinning using a starting material of easily-graphitizable carbon, a step of subjecting the fiber to an infusibilizing treatment at a heating temperature T₁ set in a range of 200° C. ≦T₁≦400° C. for a heating time t₁ set in a range of 0.5 hour≦t₁≦10 hours in an atmospheric current, a step of subjecting the infusibilized fiber to a carbonizing treatment at a heating temperature set in a range of 600° C. ≦T₂≦900° C. for a heating time t₂ set in a range of 0.5 hour≦t₂≦10 hours in an inert gas current to provide a fibrous carbonized material, a step of subjecting the fibrous carbonized material to a pulverizing treatment to provide a powdered carbonized material, a step of subjecting the powdered carbonized material to an alkali activating treatment at a heating temperature T₃ set in a range of 500° C. ≦T₃≦1,000° C. for a heating time t₃ set in a range of 0.5 hour ≦t₃≦10 hours in an inert gas atmosphere.

5. The method for preparing of claim 4 wherein the step of subjecting the powdered carbonized material to an alkali activating treatment is followed by an acid-washing, a water-washing, a filtration and a drying.

6. The method of claim 4 wherein the starting material of the easily graphitizayle carbon is selected from the group of materials consisting of:
meso-fused pitch, coke, petroleum pitch, a polyvinyl chloride, a polyimide, PAN and combinations of any of these materials.

7. An activated carbon for an electrode of an electric double-layer capacitor including a plurality of crystallites having a graphite structure in an amorphous carbon, wherein the interlaminar distance d₀₀₂ of the plurality of crystallites is at least 0.388.

8. The activated carbon of claim 7 wherein said interlaminar distance is at least 0.395.

9. The activated carbon of claim 7 wherein said interlaminar distance d₀₀₂ of the plurality of crystallites is in a range of 0.395≦d₀₀₂≦0.420 nm.
